(19) United States
(12) Patent Application Publication
(10) Pub. No.: US 2019/0259065 A1
(43) Pub. Date: Aug. 22, 2019

(54) BILPIX GEO CENTRIC BILLBOARD

(71) Applicant: OSCAR DALVIT, SANTARCANGELO DI ROMAGNA (RIMINI) (IT)

(72) Inventor: OSCAR DALVIT, SANTARCANGELO DI ROMAGNA (RIMINI) (IT)

(21) Appl. No.: 15/902,475

(22) Filed: Feb. 22, 2018

(51) Int. Cl. G06Q 30/02; H04W 4/02; H04W 4/23

(52) U.S. Cl. CPC G06Q 30/0261; H04W 4/23; H04W 4/025; G06Q 30/0267

(57) ABSTRACT

A method and system of displaying at least one advertisement to at least one user selected from a billboard based on a plurality of parameters and preloading the billboard content performed by an apparatus for displaying the at least one advertisement content. The apparatus includes a display unit, a display region variation determining unit, a preloading controller, and a preloading performing unit. The method includes displaying a display region, preloading an application in a memory of a mobile computing device based on data stored in a server and displaying an application launch icon in a launch area of a display of the mobile computing device. Further, the determining step is performed by the preloading controller and the downloading is performed by the preloading performing unit.

### BACKGROUND OF THE INVENTION

### Field of the Invention

Embodiments of the present invention relate to method of drawing information on a computer or phone screen in a new way, with an aim to make them user friendly and more understandable for the standard users systems, and more particularly, to communication on handheld devices, and more specifically, but not exclusively to providing advertising information on mobile devices.

### Description of the Related Art

It is well known fact that after industrial revolution the internet era is the biggest disruption that brings together the human beings on a single online platform. People can connect with anyone on this planet via the online communication. Currently, mobile handheld devices have become a major mechanism of communication. To keep up with the pace and demand of the internet users which is increasing in an exponential curve, all the information is being provided on mobile devices to the users for ease. In the current era of marketing, advertising information may include graphics, text, sound, or the like. The brand information may be provided through a variety of mechanisms on a mobile device to the user. Over the years, Global Positioning System (GPS) technology has improved our ability to detect precise geo-locations of the users in real time. GPS integration into mobile devices enables mobile detection of these locations very easily. However, while GPS technology may provide accurate coordinates, it does not always provide other meaningful information about the location and brand details by executing a set of instructions for sending out push notifications for the merchant to the potential customers.

Conventionally, in the existing systems and methods for brand advertisements, any type of ordering on the display screen of the user is possible. For grouping data charts can be prepared in excel. There are many possibilities of illustrating data to the end user one of which is grouping data as a starting point sorted by increasing values. There are existing systems and methods based on auto focus on an algorithm of drawing which is perfect to be connected to any algorithm that is able to produce a range of data sorted from a starting point.

Currently in the prior art, there is no existing systems and methods which is able to manage drawing, placement of the cells on the screen and organizing of the advertisement billboard to manage any dimension in real time and provide the same to the end user on the user interface of the mobile device.

Accordingly, there remains a need in the mobile technology domain to develop systems and methods which is able to manage drawing, placement of the cells on the screen and organizing of the advertisement billboard to manage any dimension in real time and provide the same to the end user on the user interface of the mobile device. Henceforth, there exists a need in the art for a method and system for detecting geolocation based methods, systems, devices and apparatus.

Therefore, the present invention relates to systems and methods that focuses on the drawing algorithm being organized in cells and subcells which are able to work in unlimited size but within the limit of the device memory of the user device.

### SUMMARY OF THE INVENTION

Embodiments of the present disclosure relates to geolocation based methods, systems, devices and apparatus. In one embodiment, the present invention disclose a method including the steps of data preloading and preparation, evaluating spiral placement of brand advertisements based on calculations, and rendering the final description of the brand advertisements. Therefore, the present invention discloses organization of advertisement data on a billboard format on an user interface of the user device.

Embodiments of the present disclosure discloses, a method of displaying at least one advertisement to at least one user selected from a billboard based on multiple parameters and preloading the billboard content performed by an apparatus for displaying one or more advertisement based content. Particularly, the apparatus includes a display unit, a display region variation determining unit, a preloading controller, and a preloading performing unit. The present method includes the steps of displaying a display region of the at least one advertisement content, and the display is provided by the display unit, preloading an application in a memory of a mobile computing device based on data stored in a server, for example: at least in part on the monitored activity and displaying an application launch icon in a launch area of a display of the mobile computing device. In operation, the determination is performed by the preloading controller and the downloading is performed by the preloading performing unit.

In accordance with one aspect of the present invention, a display region determining unit determines installation of at least one application on a mobile computing device. Particularly, the method further includes receiving an input from the user regarding application launch and wherein it is determined that the at least one application is not accessible on the mobile computing device by the user.

In accordance with another embodiment of the present invention, the method may further include the steps of retrieving data from the server and storing application in the memory of the mobile computing device, processing retrieved data from the server and displaying the retrieved data to the user by generating a plurality of visible advertisement blocks based on GPS location of said user and a plurality of parameters, and creating texture and assigning map for touch event based on GPS location based on a field parameter for each visible advertisement block of the plurality of visible advertisement blocks. Particularly, each visible advertisement block of the multiple visible advertisement blocks are visible objects during pan or zoom.

Embodiments of the present disclosure disclose, a system for displaying at least one advertisement to one or more user selected from a billboard based on multiple parameters and preloading the billboard content performed by an apparatus for displaying one or more advertisement content on a local handheld device.

Particularly, the system further includes the display unit, the display region variation determining unit, the preloading controller, and preloading performing unit, including a display region of one or more advertisement content.

Furthermore, displaying is performed by the display unit with preloading an application in a memory of a mobile computing device based on data stored in the remote server.

Particularly, one or more processors and one or more computer-readable media having stored thereon instructions that are executable by one or more processors to configure said system to display one or more advertisements, including instructions that are executable to configure said system to perform one or more functions.

Hence at the mobile computing device which is connected to the remote server, and the remote server provides location of the user by tracking location of the mobile computing device.

Furthermore, the determining is performed by the preloading controller and the downloading is performed by the preloading performing unit.

Particularly, the mobile computing device receive input from the remote server regarding application launch;

In operation of the mobile computing device determining the location of the wireless device by obtaining and receiving locating signals by said wireless device.

Furthermore, the remote server provide displaying an application launch icon in a launch area of a display of the mobile computing device and the display region determining unit determines installation of one or more application on a mobile computing device.

The system for displaying one or more one advertisement to one or more user selected from a billboard based on multiple parameters and preloading the billboard content performed by an apparatus for displaying one or more advertisement content on local handheld device.

Particularly, the system includes a display unit, a display region variation determining unit, a preloading controller, and a preloading performing unit, including a display region of the one or more one advertisement content.

Furthermore, the displaying is performed by the display unit with a preloading an application in a memory of a mobile computing device based on data stored in a remote server.

Accordingly, there are one or more processors and one or more computer-readable media having stored thereon instructions that are executable by the one or more processors to configure the system to display one or more advertisements.

In operation, the instructions are executable to configure the system to perform one or more of the functions. Moreover, the determination is performed by the preloading controller and downloading is performed by the preloading performing unit. Moreover, the device receives input from the remote server and the remote server provides the input from the user regarding application launch. Henceforth, at the mobile computing device determining the location of the wireless device is performed and, at the the mobile computing device locating signals by the wireless device is obtained. Therefore, the remote server provide displaying an application launch icon in a launch area of a display of a mobile computing device and a display region determining unit determines installation of one or more one application on a mobile computing device.

The system for providing advertisement information based on a user location is disclosed in the present invention. Moreover, the one or more mobile computing devices further have stored thereon instructions that are executable by the one or more processors to configure the system in the mobile computing device to cause the mobile computing device to display region determining unit to determine installation of one or more applications on a mobile computing device.

Henceforth, it is determined that the one or more one applications is not accessible on the mobile computing device by the user, the system further includes the steps of retrieving data from the server and processing retrieved data from the server as a server deserialized data and display the retrieved data to the user by generating a plurality of visible advertisement blocks based on GPS location of the user and a plurality of parameters based on real time and creating texture and assigning map for touch event based on GPS location based on a field parameter for each visible advertisement block of the plurality of visible advertisement blocks which are visible objects during pan or zoom.

In another embodiment of the present invention, it is determined that the one or more applications is not accessible on the mobile computing device by the user, the system further includes the steps of retrieving data from the server and processing retrieved data from the server as a server deserialized data and displaying the retrieved data to the user by generating a plurality of visible advertisement blocks based on GPS location of the user and a plurality of parameters based on real time and creating texture and assigning map for touch event based on GPS location based on a field parameter for each visible advertisement block of the plurality of visible advertisement blocks is defined by a mega Cell Size and processing is based on background as corou.

Therefore, the mobile device deserialized data version is replaced with the data stored in the server in real time when it is determined that the size of the plurality of visible advertisement blocks stored in the server is more than the mobile device deserialized data version with data stored in the server.

Henceforth, the advertisement information based on a user location display one or more one advertisements to one or more users is via the plurality of means AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a pictorial snapshot illustrating an example of a plurality of businesses sorted by distance from one or more users, according to one embodiment of the present invention;

FIG. 1B is a pictorial snapshot illustrating the position of the user, according to one embodiment of the present invention;

FIG. 2 is a pictorial snapshot illustrating a graphical representation in X axis and Y axis, according to one embodiment of the present invention;

FIG. 3 is a pictorial graphical snapshot illustrating of master [0,0] rendering, where master [x,y] coordinate zone is part of MEGA billboard which is generated on the server, according to one embodiment of the present invention;

FIG. 4 is a pictorial graphical snapshot of an example which shows every subcell at [map X, map Y] has separated json file with definition, according to one embodiment of the present invention;

FIG. 5 is a graphical pictorial snapshot illustrating a spiral path calculation, according to one embodiment of the present invention;

FIG. 6A is a graphical pictorial snapshot of numerous advertisements illustrating on spiral path, according to one embodiment of the present invention;

FIG. 6B is a graphical pictorial snapshot illustrating depiction of how to determine advertisement free cells in grid when trace direction is right side and/or down side, according to one embodiment of the present invention;

FIG. 6C is a graphical pictorial snapshot illustrating determination of advertisement to grid for top side and/or right side, according to one embodiment of the present invention;

FIG. 6D is a graphical pictorial snapshot illustrating determination of one or more advertisement free cells in grid when trace direction is left and/or up, according to one embodiment of the present invention;

FIG. 6E is graphical pictorial snapshot illustrating placement of advertisement to grid for the left side and/or bottom side, according to one embodiment of the present invention;

FIG. 7A and FIG. 7B are flow diagrams illustrating a method of billboard processing and displaying one or more advertisements to one or more users, according to one embodiment of the present invention;

FIG. 8 is a pictorial snapshot illustrating subdivision of MEGA billboard, according to one embodiment of the present invention;

FIG. 9 is a block diagram illustration of an exemplary computer system within which various aspects of the disclosure can be implemented, according to one or more embodiments of the present invention;

FIG. 10 is the example system that can be used in implementations of the present disclosure, according to one embodiment of the present invention; and

FIG. 11 is an example environment for billboard processing and display of one or more advertisements to one or more users, according to one embodiment of the present invention.

### DETAILED DESCRIPTION

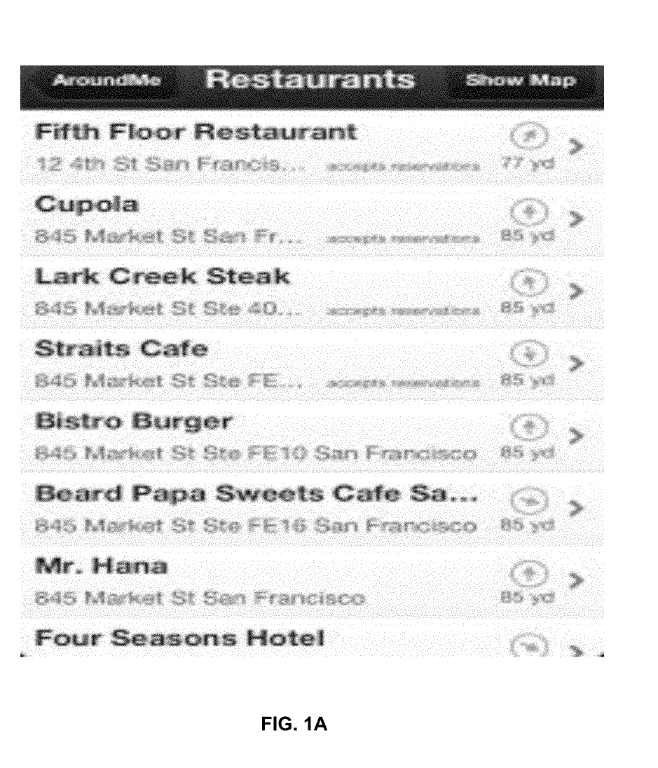

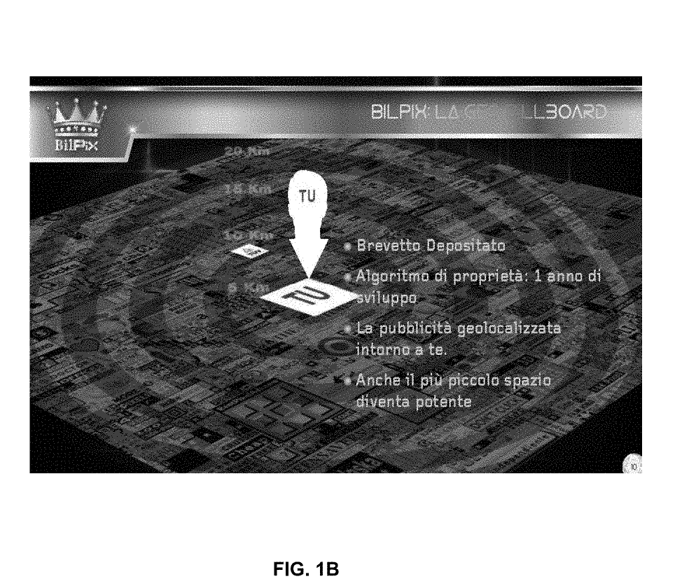

Various embodiments of the present invention provide systems, devices, apparatus and methods of retrieving information on a desktop computer or a handheld phone screen in an innovative way, with an aim to make them user friendly and more understandable for the standard users systems, and more particularly, to communication on handheld devices, and more specifically, but not exclusively to providing advertising information on mobile devices. The present invention provide systems to show information sorted by one criteria, for example from smaller to largest, from nearest to farthest, the closest to my interests etc. Moreover, the principles of the present invention and their advantages are best understood by referring to FIG. 1 to FIG. 11.

In the following detailed description of illustrative or exemplary embodiments of the disclosure, specific embodiments in which the disclosure may be practiced are described in sufficient detail to enable those skilled in the art to practice the disclosed embodiments. For example, specific details such as specific method steps, structures, elements, and connections are presented herein. However, it is to be understood that the specific details presented need not be utilized to practice the embodiments of the present disclosure.

The following detailed description is, therefore, not to be taken in a limiting sense, and the scope of the present disclosure is defined by the appended claims and equivalents thereof.

References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others.

Similarly, various requirements are described which may be requirements for some embodiments but not other embodiments.

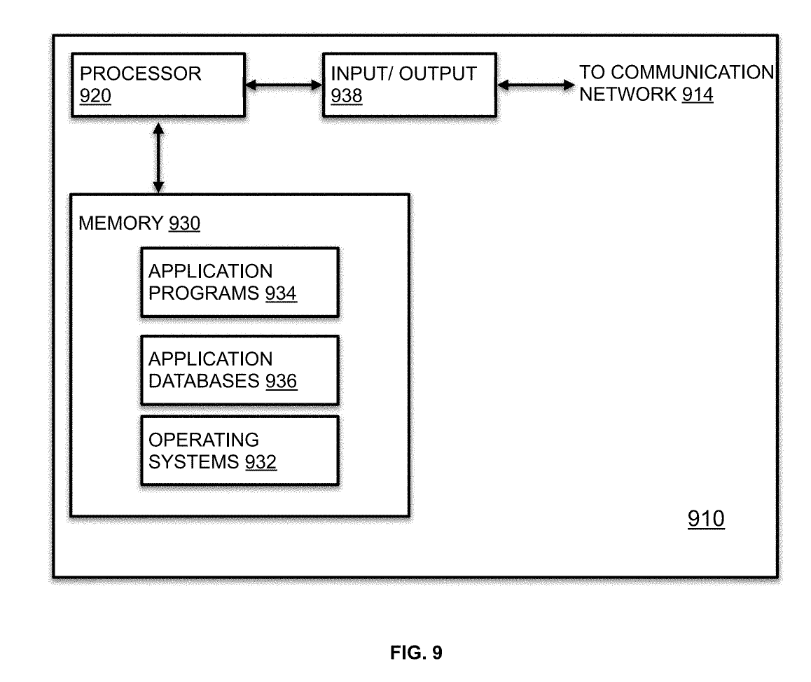

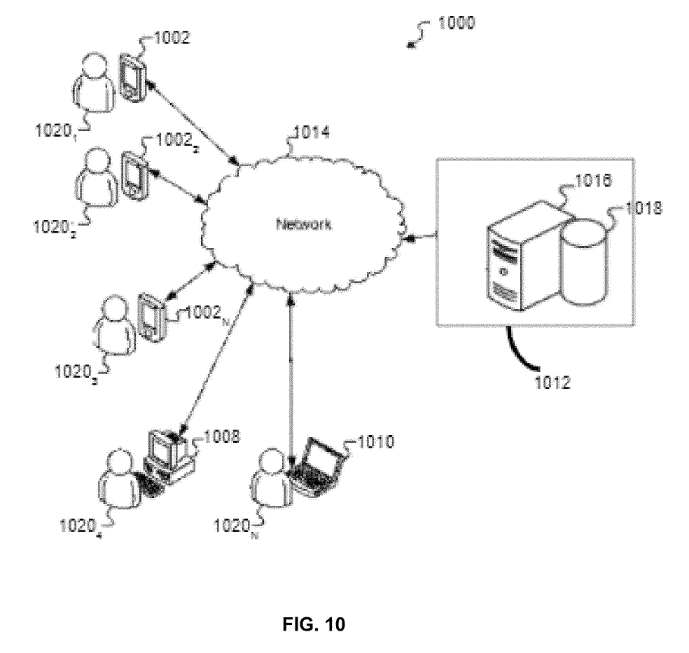

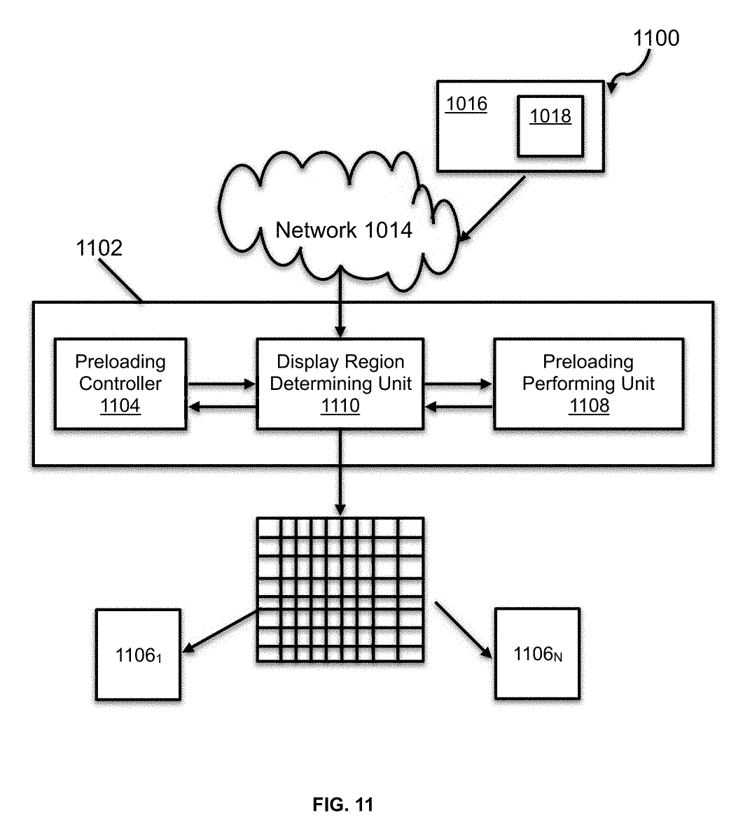

FIG. 9 is a block diagram illustration of an exemplary computer system within which various aspects of the disclosure can be implemented, FIG. 10 is the example system that can be used in implementations of the present disclosure, and FIG. 11 is an example environment for billboard processing and display of one or more advertisements to one or more users, according to one embodiment of the present invention.

With reference now to the figures, particularly like reference numbers denote like parts, FIG. 9 illustrates a typical hardware configuration of a computer processing system 910 which is representative of a hardware environment for practicing the present invention. Referring to FIG. 9, computer system 910 may have one or more processors 920 coupled to various other components. A computer operating system 932 may run on processor 920 and control and coordinate the functions of the various components of FIG. 9. Furthermore, application programs 934 stored in memory 930 and coupled to various application databases 936 may run in conjunction with operating system 932 and provide calls to operating system 932 where the calls implement the various functions or services to be performed by application programs 934. Applications may be further broken down into program modules.

Application programs 934 include, for example, an application for displaying at least one advertisement to at least one user 1020₁, 1020₂, . . . 1020_{N} selected from a billboard based on multiple parameters and preloading the billboard content is performed by an apparatus for displaying the one or ore advertisement content on a local handheld device 1002₁, 1002₂, . . . 1002_{N}.

In one embodiment, the various application databases 936 store advertisement data as disclosed in the present invention.

In another embodiment, the various application databases 936 include data storage for one or more processors 920 and one or more computer-readable media having stored thereon instructions that are executable by one or more processors 920 to configure the system 1000 to display one or more advertisements, including instructions that are executable to configure the overall system 1000 to perform functions.

In yet another embodiment, the various application databases 936 include modules to receive input from the remote server 1012. The remote server 1012 provides the input from the user 1020₁, 1020₂, . . . 1020_{N} regarding application launch and determining the location of the wireless device 1002₁, 1002₂, . . . 1002_{N} and computing device 1008, 1010 obtain and receive locating signals by the wireless device 1002₁, 1002₂, . . . 1002_{N}.

Henceforth, as described in more detail below in association with FIG. 9, it should be noted that software components including operating system 932 and the application programs 934 of the present invention may be loaded into the processing system's main memory 930 for execution. Accordingly, at the mobile computing devices 1002₁, 1002₂, . . . 1002_{N} and laptop 1010 (as illustrated in FIG. 10) are connected to the remote server 1012 via the communication network 1014. Particularly the remote server 1012 provides location of the user 1020₁, 1020₂, . . . 1020_{N} by tracking location of the mobile computing devices 1002₁, 1002₂, . . . 1002_{N}.

FIG. 10 depicts an example system 1000 that can be used in implementations of the present disclosure. The example system 1000 includes a plurality of client computing devices 1002₁, 1002₂, . . . 1002_{N}, 1008, 1010 each of the computing devices 1002₁, 1002₂, . . . 1002_{N}, 1008, 1010 being associated with one of users 1020₁ to 1020_{N}. The system 1000 also includes a network 1014, and the remote server 1012. The computing devices 1002₁, 1002₂, . . . 1002_{N}, 1008, 1010 and the remote server 1012 can communicate with each other through the network 1014.

Particularly, the computing system 1012 can include one or more mobile computing devices 1002₁, 1002₂, . . . 1002_{N} and one or more computer-readable storage devices 1008 and 1010. Moreover, each of computing devices 1002₁, 1002₂, . . . 1002_{N}, 1008 and 1010 can represent various forms of processing devices. Example processing devices can include a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or a combination of any these data processing devices or other data processing devices.

Further, the computing devices 1002₁, 1002₂, . . . 1002_{N}, 1008 and 1010 can be provided access to and/or receive application software executed and/or stored on any of the other remote server 1012. The remote server 1012 can represent various forms of servers including, but not limited to a web server, an application server, a proxy server, a network server, or a server farm.

In some examples, the computing device 1002₁, 1002₂, . . . 1002_{N}, 1008 and 1010 performs functions of a social network server 1012. In some implementations, the computing devices can communicate wirelessly through a communication interface (not shown), which may include digital signal processing circuitry where necessary. The communication interface can provide for advertisement information based on a user location of under various modes or protocols, AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

In another embodiment the communication interface can provide for advertisement information based on the user location of under various modes or protocols for the ticket and/or authorization is purchased and provided using the wireless device via the Internet, a WiFi connection, a network, a wireless network, a USB connection, or any combination thereof by triangulation, by a local positioning (LPS) device, by a global positioning system (GPS), or by any combination thereof.

In yet another embodiment the communication interface can provide for advertisement information based on a user location of under various modes or protocols based on FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

For example, the communication interface 914 can also provide for advertisement information based on a user location may occur through a radio-frequency transceiver (not shown). In addition, short-range communication may occur, such as using a Bluetooth, WiFi, or other such transceiver.

In some implementations, the system 1000 can be a distributed client/server 1012 system that spans one or more networks such as the network 1014. The network 1014 can be a large computer network, such as a local area network (LAN), wide area network (WAN), the Internet, a cellular network, or a combination thereof connecting any number of mobile clients, fixed clients, and servers 1012. In some implementations, each client (e.g., computing devices 1002-1010) can communicate with servers 1012 (e.g., computing device 1016) via a virtual private network (VPN), Secure Shell (SSH) tunnel, or other secure network connection. In some implementations, the network 1014 can further include a corporate network (e.g., internet) and one or more wireless access points.

FIG. 11 depicts an example environment 1100 for advertisement cross-referencing based on displaying at least one advertisement by the remote server 1012 and display unit system 1102. The display unit system 1102 can be implemented, for example, using one or more computing systems (e.g., the computing system 1002₁, 1002₂, . . . 1002_{N}, 1008 and 1010 of FIG. 10). Particularly the term display unit system 1102 and the apparatus have been used interchangeably in the present invention for ease.

By way of a non-limiting example, one or more advertisement content 1112 is displayed on an application launch icon in a launch area of a display of the mobile computing device 1106_{1-N.} However, the computing system 1002₁, 1002₂, . . . 1002_{N}. 1008 and 1010 and mobile computing device 1106_{1-N} numbering are used interchangeably for convenience.

The example environment 1100 includes the system which includes the display unit 1102, with the display region variation determining unit 1110, the preloading controller 1104, and the preloading performing unit 1108 and displaying is performed by the display unit 1102 with the preloading an application in the memory 930 of the mobile computing device 1106_{1-N} based on data stored in the remote server 1012 and displays the advertisement content 1112 on the mobile computing device 1106_{1-N}.

The mobile computing device 1106₁₋ₙ connect to the remote server 1012 and the remote server 1012 provides location of the user 1020₁ to 1020ₙ by tracking location of the mobile computing device 1106₁₋ₙ. The location determining is performed by the preloading controller 1104 and downloading is performed by the preloading performing unit 1108 by receiving input from the remote server 1012. The remote server 1012 provides the input from the user regarding application launch. At the mobile computing device 1106_{1-N} determining the location of the wireless device by obtaining and receiving locating signals by the wireless device 1106_{1-N}.

FIG. 1A is a pictorial snapshot 100 illustrating an example of a plurality of businesses sorted by distance from the one or more users, according to one embodiment of the present invention. To represent the data to the users a simple list ordered with values from top to bottom is illustrated in FIG. 1A. Particularly, FIG. 1A is an example of list of businesses sorted by distance. In operation, the geo billboard flow of the present invention is divided into three parts, first part is data preloading and preparation, second is spiral placement calculation and third is rendering.

FIG. 1B is a pictorial snapshot illustrating the position of the user, according to one embodiment of the present invention. Particularly, the user is placed in the center and is organized by concentric sorting the blocks as illustrated in FIG. 1B. The term “block” in the present invention relates to one or more cells organized in squares or rectangles. Particularly, the present invention discloses systems and methods to organize data on a billboard format and present the same to the user 1020₁, 1020₂, . . . 1020_{N} on the user interface of the user device.

In one embodiment, the billboard is of about 60M pixels divided into squares and the each cell grid is of about 10×10 pixels with the billboard about 60M pixels. However, the present invention is not limited to 60M pixels and the dimension of the billboard is dynamic and is set according to the memory of the device.

Moreover, as illustrated in the FIG. 1B the user is positioned in the center and organized by concentric sorting the blocks. The result of the present method displays information around and near a center point of the user location. The present method is able to show the business near him or her which is based on a number of parameters. The parameters are distance from the user 1020₁, 1020₂, . . . 1020_{N} hecan scroll, zoom in and out of the billboard.

Moreover, even a small block but near the center of the user 1020₁, 1020₂, . . . 1020_{N} attracts the curiosity of the user 1020₁, 1020₂, . . . 1020_{N} with a zoom in and out feature, the user 1020₁, 1020₂, . . . 1020_{N} is led to discover the blocks near his position. Furthermore, the present invention generates new interactions with the data then a simple list of results are sorted on the screen of the user device.

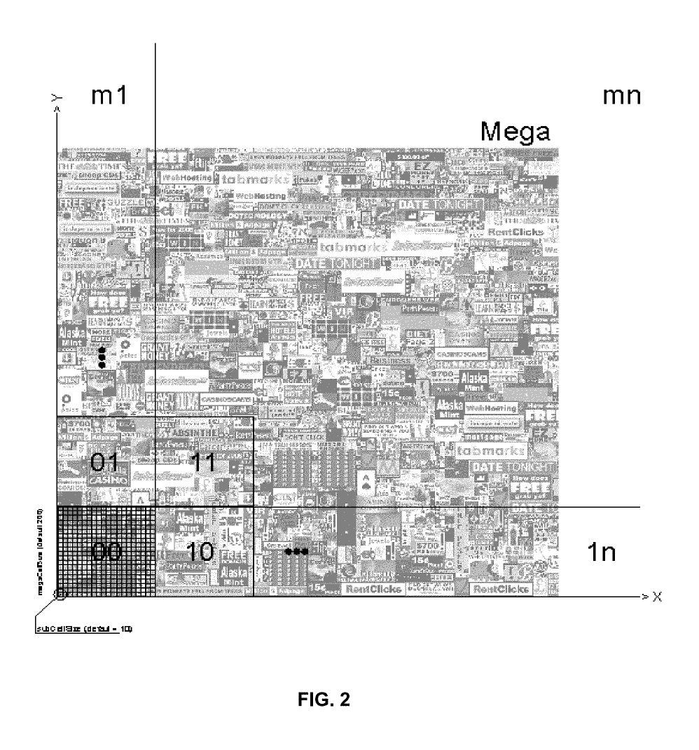

FIG. 2 is a pictorial snapshot illustrating a graphical representation in X axis and Y axis, according to one embodiment of the present invention. In operation, the present implementation of the method according to one embodiment is able to draw and illustrate on a screen of the handheld device of the user 1020₁, 1020₂, . . . 1020_{N} the cells and blocks by limiting the free spaces, and managing the placement of the two blocks when the two blocks are on same position. Further, the billboard is divided into multiple sub-cells and a number of cells to have high performance and theoretically unlimited size. Particularly, the present system and method is able to draw on the screen of the user device the cells and blocks by limiting the free spaces, and managing the placement when two blocks are on same position.

In one embodiment, depending on the memory size of the device there are critical ranges of size, weight, pressure, and the like. Moreover, the data generated and illustrated to the user 1020₁, 1020₂, . . . 1020_{N} as cloud tag.

In one embodiment, the main classes for GEO billboard processing is viewed on the screen most popular tags having big values than the less popular tags on the the display of the user device 1002₁, 1002₂, . . . 1002_{N}, 1008, 1010.

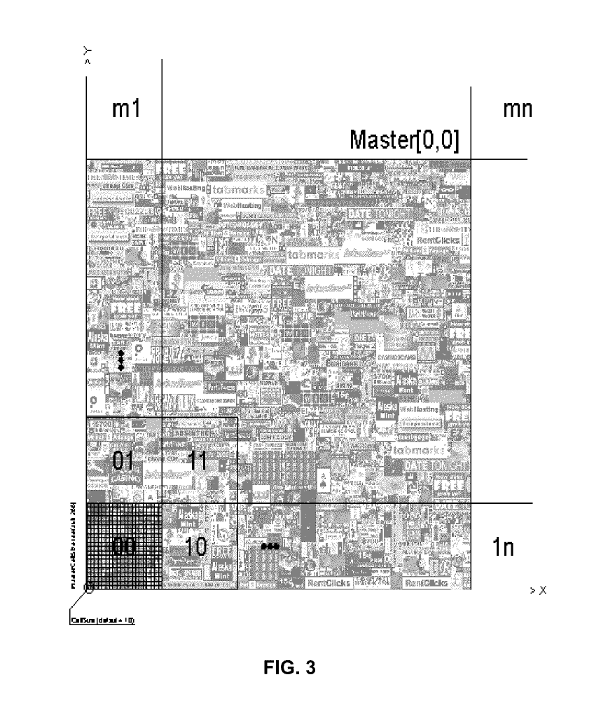

FIG. 3 is a pictorial graphical snapshot illustrating of master [0,0] rendering, where master [x,y] coordinate zone is part of MEGA billboard which is generated on the server 1012, according to one embodiment of the present invention. Particularly, the graph illustrates the system which uses rendering of one master cell at map X=0, and map Y=0. In addition, as illustrated in FIG. 3, master [x, y] zone is part of MEGA billboard, is generated on the server 1012. The server 1012 can be cloud based in one or more embodiments of the present invention. Particularly, the result from this processing is folder for every one MASTER [x, y] cell, which is part of MEGA billboard. Moreover, the rendering used relates to one MASTER cell at map X=0, map Y=0.

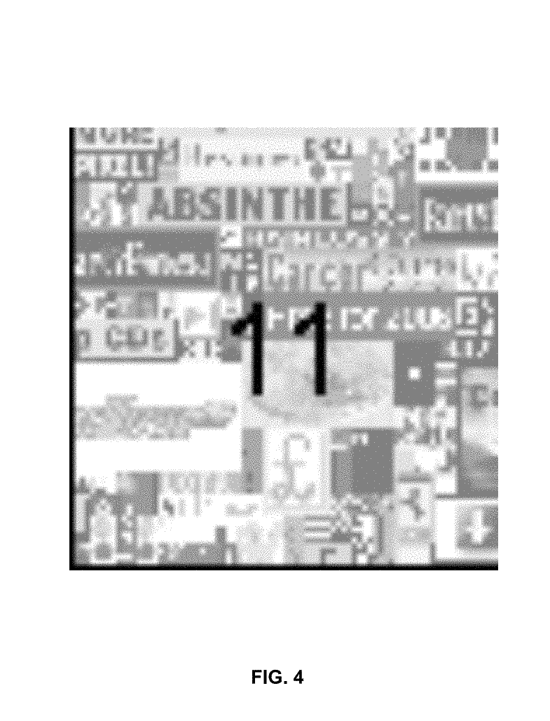

FIG. 4 is a pictorial graphical snapshot of an example which illustrates every subcell at [map X, map Y] has separated json file with definition, according to one embodiment of the present invention.

In one embodiment, the image Name=cropped PNG image from generated MEGA texture on the server 1012. In operation, name is created by position in megaGrid: image_<mapX><mapY>.png.

In another embodiment, the image Base64=encoded cropped image which is included to JSON file. However, the subcell data is not loaded twice.

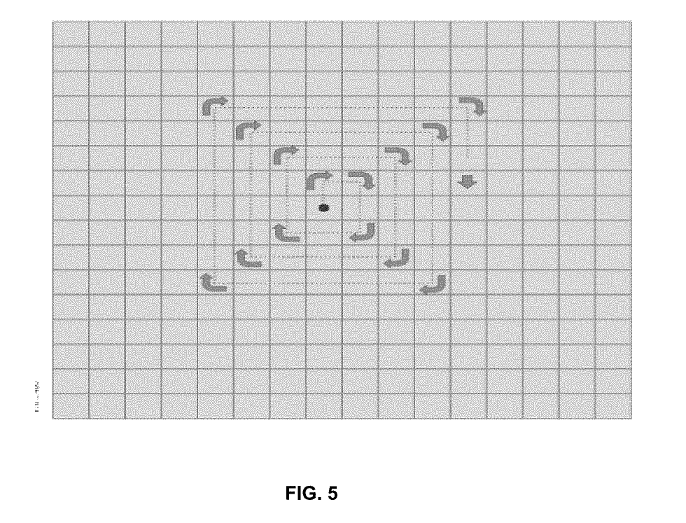

FIG. 5 is a graphical pictorial snapshot illustrating a spiral path calculation, according to one embodiment of the present invention. The present method is based on spiral path calculation. In operation, the next cell position is calculated on request by spiral tracing. Particularly, the cell position is global variable, for simple access from all methods as discussed in the description. Further, the change tracing direction in corner is always in clockwise direction. At the start position, the step is set to zero.

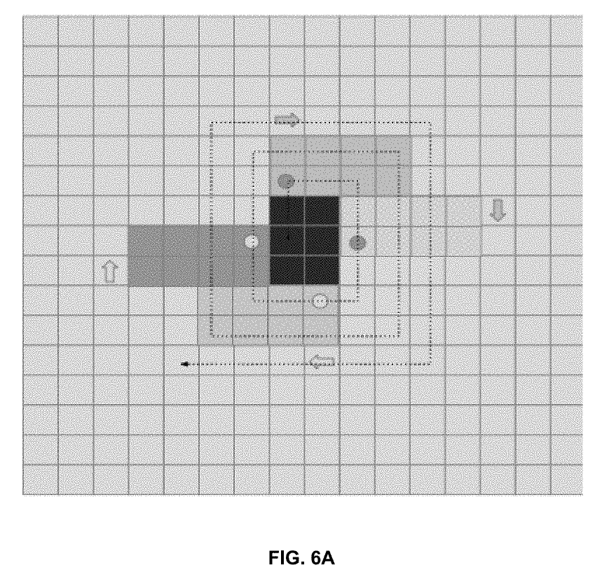

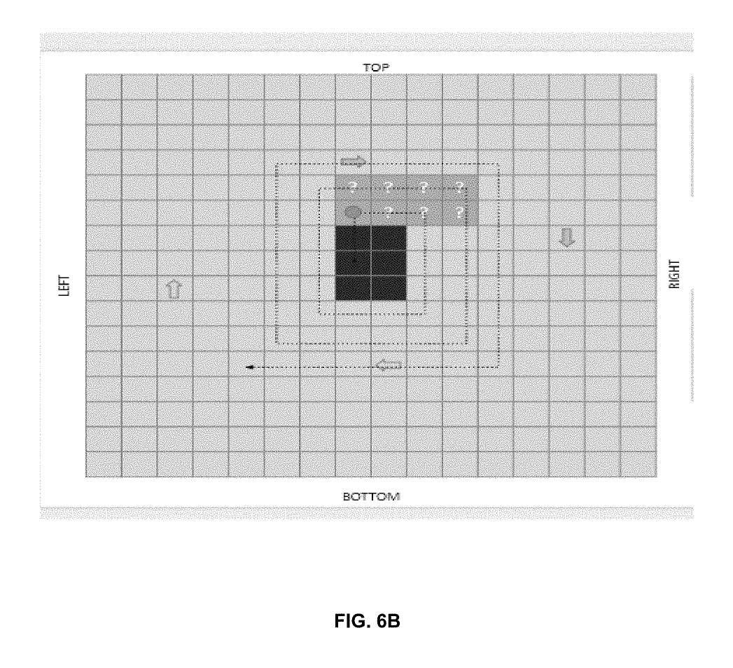

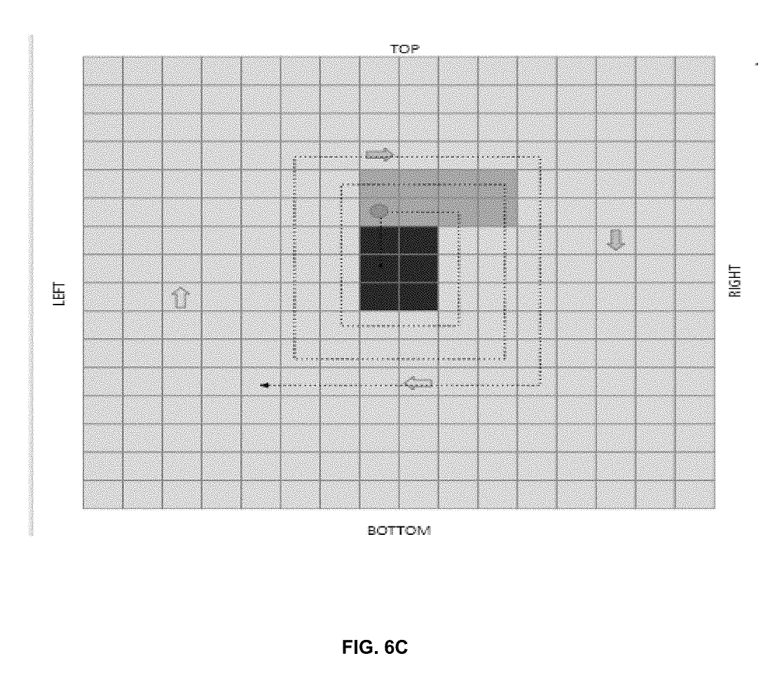

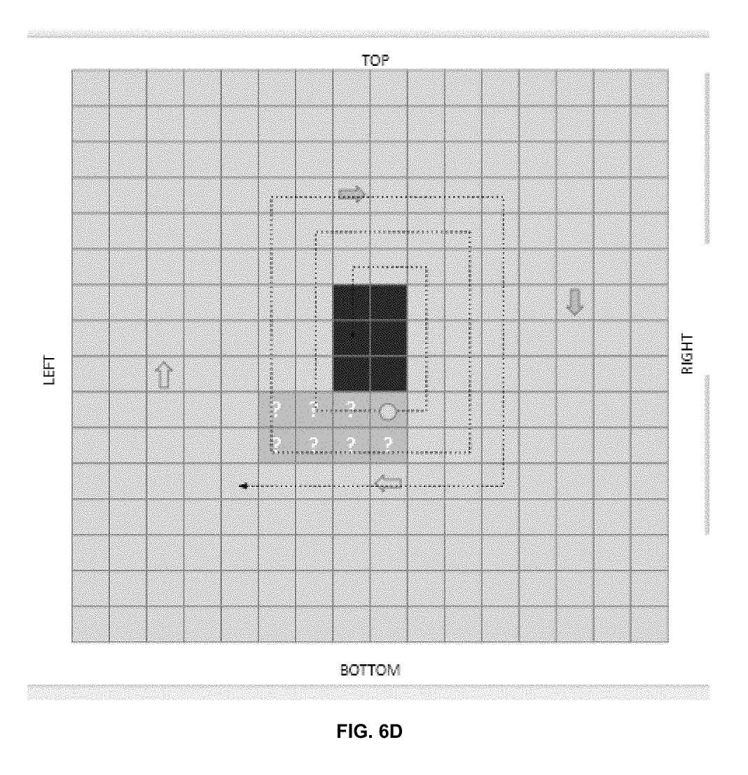

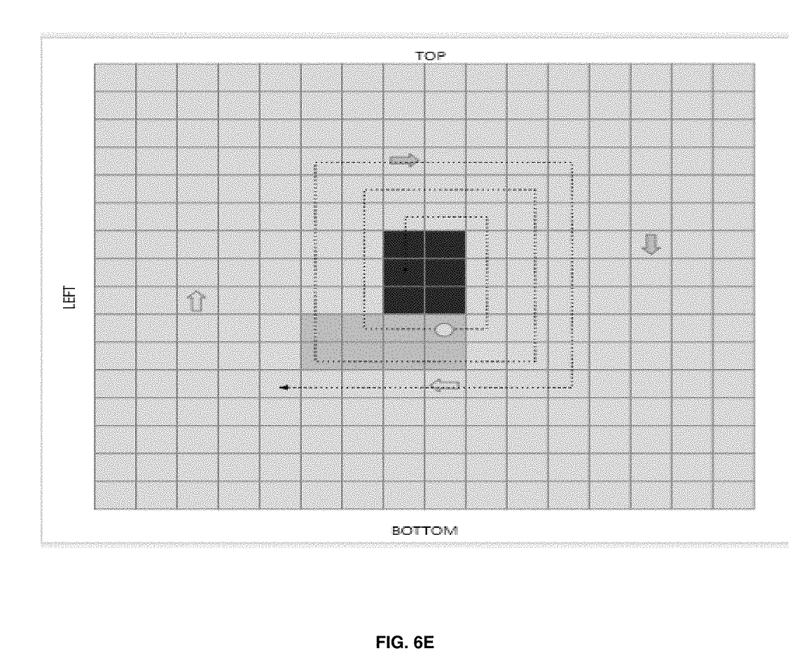

FIG. 6A is a graphical pictorial snapshot of numerous advertisements illustrating on spiral path, according to one embodiment of the present invention. The blocked grid cells 605 with a number of advertisements are illustrated in spiral trace direction. As illustrated the advertisement is placed on the grid in the spiral direction when the current trace direction is RIGHT or DOWN. Further, the snapshot illustrates width and height. The fixed advertisement pivot from bottom left [X, Y] and free space is checked from bottom-left to top-right. Usually, the advertisement is placed to grid on spiral when current trace direction is LEFT or UP. The calculation is based on following formula whereby virtual advertisement pivot−top right=[X+width,Y+height]. The pivot for placing the advertisement is calculated as offset from bottom-left pivot mathematically. Further, only free space is checked from top-right to bottom-left,

FIG. 6B is a graphical pictorial snapshot illustrating depiction of how to determine advertisement free cells in grid when trace direction is right side and/or down side, according to one embodiment of the present invention. Particularly, the next free area for advertisement is determined. The recursive loop for trace space for current advertisement is defined in T Image cell. The oval shape is able to determine free cell in grid on spiral. The question mark 610 in the cell are checked by advertisement shape. The present method is able to determine whether all cells are free.

In one embodiment, if it is determined that the one or more cells are free the advertisement is placed at the free position.

In another embodiment, if it is determined that the one or more cells are not free then the advertisement is not placed in the cell.

In one embodiment, the present method determines if the advertisement can be positioned on the calculated position depending on the position around grid center which is inherited from trace direction.

FIG. 6C is a graphical pictorial snapshot illustrating determination of advertisement to grid for top side and/or right side, according to one embodiment of the present invention. Particularly, the advertisement is positioned on the grid on spiral when current trace direction is top side or right side. The oval shape relates to fixed advertisement pivot−bottom left [X, Y] as illustrated in FIG. 6C.

In one embodiment, the present method determines if the advertisement is possible to be placed on the calculated position depending on the trace direction LEFT.

FIG. 6D is a graphical pictorial snapshot illustrating determination of one or more advertisement free cells in grid when trace direction is left and/or up, according to one embodiment of the present invention. Particularly, the present method determines next free area for advertisement. The recursive loop determines the trace space for current advertisement and is defined in TOmage cell. The yellow oval contour illustrates founded free cell in grid on spiral. Further, a determination is made as to determine the checked cell by advertisement shape.

In one embodiment, the present method determines if the one or more cells of the billboard are free. If the one or more cells are free the advertisement is placed and if the one or more cells are not free the advertisement is placed to next free cell.

In one embodiment, the present method determines if advertisements is possible and positioned on calculated position depending on position around grid center which is inherited from trace direction.

FIG. 6E is graphical pictorial snapshot illustrating placement of advertisement to grid for the left side and/or bottom side, according to one embodiment of the present invention. Particularly, the advertisement is placed to GRID on spiral when current trace direction is LEFT or UP. The yellow oval spot relates to virtual advertisement pivot−top right [X, Y]. The pivot for placing advertisement is calculated as offset from bottom-left pivot mathematically.

In one embodiment, the present method determines if advertisements is possible and positioned on calculated position depending on trace direction LEFT private bool Add_bottom_ad which is the TImageCell cell and private bool Add_left_ad is TImageCell cell.

In one embodiment, the trace direction is bottom or left then the present method uses virtual pivot for free space check instead real pivot from bottom-left direction. Further, the cell X and cell Y are override in Tlmage Cell item.

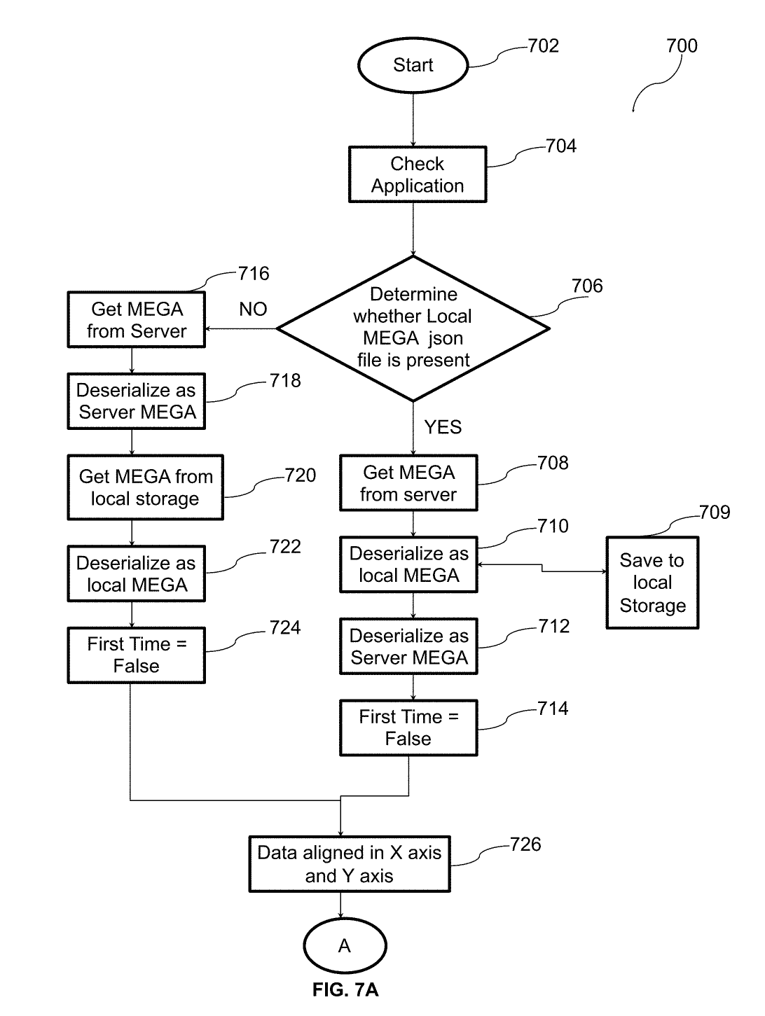

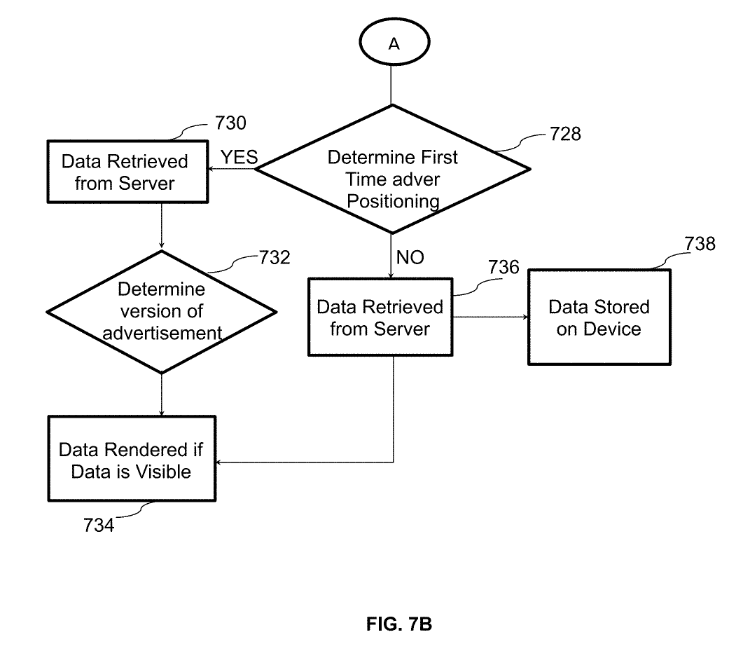

FIG. 7A and FIG. 7B are flow diagrams illustrating the method 700 of billboard processing and displaying one or more advertisements to one or more users 1020₁, 1020₂, . . . 1020_{N}. The one or more advertisements 1112 are selected from a billboard based on multiple parameters and the billboard content is preloaded which is performed by an apparatus for displaying the at least one advertisement content. At step 702 the process starts and proceeds to step 704. In one embodiment, at step 704 the application is preloaded in a memory of a mobile computing device 1002₁, 1002₂, . . . 1002_{N} based on data stored in a server 1012 for example: at least in part on the monitored activity and the application launch icon in a launch area of a display of the mobile computing device 1002₁, 1002₂, . . . 1002_{N} is displayed to the user. Particularly, this step relates to data preloading and preparation. In operation, the data is stored in single JSON file with structure and name “XYZ” on the server 1012. The method proceeds to step 706. At step 706, a determination is made as to whether installation of at least one application on the mobile computing device 1002₁, 1002₂, . . . 1002_{N} in the display region is provided to the user. Particularly, the determination is performed by the display region determining unit of the mobile computing device. In operation, the data is determined in the local storage memory on the user device 1002₁, 1002₂, . . . 1002_{N}, 1008, 1010.

In one embodiment, if the data is found missing in the user device 1002₁, 1002₂, . . . 1002_{N}, 1008, 1010 the step 706 proceeds to step 708. Steps 708, 709, 710, 712 and 714 are executed and the data is loaded from the server 1012 and stored to local storage memory of the user device 1002₁. The method 700 proceeds to step 726. The step 726 illustrated by the alphabet “A” in FIG. 7A and the rest of the method 700 is explained in FIG. 7B.

In one embodiment, if the data is not found missing in the user device 1002₁, 1002₂, . . . 1002_{N}, 1008, 1010 and then the step 706 proceeds to step 716. Steps 718, 720, 722, and 724 are executed and the data exists in the memory of the device 1002₁. Further, the data is retrieved for the user. The method 700 proceeds to step 726. At step 726, the data is aligned in X and Y coordinates. The step 726 proceeds to step 728. At step 728 a determination is made as to whether the advertisement is to be positioned in the one or more cells of the billboard for the first time.

In one embodiment, the determination at step 728 is “YES” the method 700 proceeds to step 730. At step 730, the data is retrieved from the device memory. The method 700 proceeds from step 730 to step 732. At step 732, a determination is made to determine the version of the advertisement. If the the version of the advertisement is same the method 700 proceeds from step 732 to step 734. At step 734, the data is rendered if the data is visible.

In another embodiment, if the the version of the advertisement is not same the method 700 proceeds from step 732 to step 736. At step 736, the data is retrieved from the server 1012 onto the device 1002₁, 1002₂, . . . , 1002_{N}, 1008, 1010. The method 700 proceeds from step 736 to step 738. At step 738, the data is stored on the memory of the user device 1002₁, 1002₂, . . . 1002_{N}, 1008, 1010.

Therefore, after retrieving the loaded data, the data is deserialized to data control. From the retrieved data the object creates a list of all advertisements with ID and distance properties. For all advertisements in the list, distance between advertisement GPS and application user GPS coordinates are calculated and stored in distance field. When all distances are calculated, then it is called redefined IComparison, for sorting all items in list by distance. In operation, installation of at least one application on a mobile computing device 1002₁, 1002₂, . . . 1002_{N} in said display region is determined. Further, the determination is performed by the display region determining unit, and the location of an user 1020₁, 1020₂, 1020_{N} is determined by tracking location of the mobile computing device 1002₁, 1002₂, . . . 1002_{N}. In use, the determination step is performed by the preloading controller 1104 and the downloading is performed by the preloading performing unit 1108.

In one embodiment, the method of displaying at least one advertisement 1112 to at least one user 1106_{1-N} selected from the billboard based on a plurality of parameters and preloading the billboard content performed by the apparatus (display unit system 1102) for displaying the at least one advertisement 1112 content includes display unit 1102, display region variation determining unit 1110, preloading controller 1104 and preloading performing unit 1108. The method includes the steps of displaying a display region of the at least one advertisement content 1112, wherein the displaying is performed by said display unit 1102, preloading an application in a memory of a mobile computing device 1002₁, 1002₂, . . . 1002_{N} based on data stored in a server 1012 [example: at least in part on the monitored activity] and displaying an application launch icon in a launch area of a display of the mobile computing device 1002₁, 1002₂, . . . 1002_{N} determining installation of at least one application on a mobile computing device in the display region, wherein the determining is performed by the display region determining unit 1110, determining location of an user by tracking location of the mobile computing device 1002₁, 1002₂, . . . 1002_{N}. Particularly, the determination is performed by the preloading controller 1104, and the downloading is performed by the preloading performing unit 1108. The display region determining unit determines installation of one or more application on the mobile computing device 1002₁, 1002₂, . . . 1002_{N}.

In one embodiment, the method further includes the steps of receiving an input from the user 1020₁, 1020₂, . . . 1020_{N} regarding application launch and wherein it is determined that one or more application is not accessible on the mobile computing device 1002₁, 1002₂, . . . 1002_{N} by the user 1020₁, 1020₂, . . . 1020_{N} The method further includes the steps of retrieving data from the server 1012 and storing application in the memory of the mobile computing device 1002₁, 1002₂, . . . 1002_{N}, processing retrieved data from the server 1012 as a server 1012 deserialized data and displaying the retrieved data to the user by generating a multiple visible advertisement blocks based on GPS location of the user 1020₁, 1020₂, . . . 1020_{N} and a plurality of parameters, and creating texture and assigning map for touch event based on GPS location based on a field parameter for each visible advertisement block of one or more visible advertisement blocks. Further, each visible advertisement block of one or more visible advertisement blocks are visible objects during pan or zoom.

In one embodiment, the method further includes the steps of receiving an input from the user 1020₁, 1020₂, . . . 1020_{N} regarding application launch and wherein it is determined that the at least one application 1112 is accessible on the mobile computing device 1002₁, 1002₂, . . . 1002_{N} by the user 1020₁, 1020₂, . . 1020_{N}. The method further includes the steps of retrieving the stored data by loading the application from the memory of the mobile computing device 1002₁, 1002₂, . . . 1002_{N}, processing the stored data as mobile device deserialized data and displaying the retrieved data to the user by generating a plurality of visible advertisement blocks, comparing the mobile device deserialized data version with data stored based on GPS location of the user and one or more parameters retrieved from the server 1012 in real time. Consequently, determining whether size of the plurality of visible advertisement blocks stored in the server 1012 is more than the mobile device deserialized data version with data stored in the server 1012, and creating texture and assigning map for touch event based on GPS location based on a field parameter for each visible advertisement block of the multiple visible advertisement blocks. Further, each visible advertisement block of said plurality of visible advertisement blocks [visible objects during pan or zoom} and size of said each visible advertisement block is defined by megaCellSize and processing is based on background as coroutine,

In one embodiment, the mobile device deserialized data version is replaced with the data stored in the server 1012 in real time when it is determined that the size of the multiple visible advertisement blocks stored in the server 1012 is more than the mobile device deserialized data version with data stored in the server 1012.

In one embodiment, the method for providing advertisement information based on the user 1020₁, 1020₂, . . . 1020_{N} location displays one or more advertisement 1112 to one or more user 1020₁, 1020₂, . . . 1020_{N} is via an AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

In one embodiment, the displaying of one or more advertisement 1112 to one or more user 1020₁, 1020₂, . . . 1020_{N} is provided using the wireless device 1002₁, 1002₂, . . . 1002_{N} via the Internet, a WiFi connection, a network, a wireless network, a USB connection, or any combination thereof; or the ticket and/or authorization is purchased using the wireless device via the Internet, a WiFi connection, a network, a wireless network, a USB connection, or any combination thereof, or the ticket and/or authorization is purchased and provided using the wireless device via the Internet, a WiFi connection, a network, a wireless network, a USB connection, or any combination thereof.

In one embodiment, the method further includes the steps of determining the location of the wireless device by comparing the timing of received locating signals, by comparing the phase of received locating signals, by comparing the relative arrival times of received locating signals, by triangulation, by a local positioning (LPS) device, by a global positioning system (GPS), or by any combination thereof.

In one embodiment, the received locating signals are received by the wireless device 1002₁, 1002₂, . . . 1002_{N} via an AM signal, an FM signal, a phase modulated signal, COMA, TDMA, spread spectrum, the Internet, a WiFi connection, a Bluetooth connection, a Zigbee connection, a network, a wireless network, a 3G network, a 4G network, a USB connection, or any combination thereof.

In one embodiment, a non-transitory computer-readable recording medium having recorded thereon a computer program for displaying cartoon content, the computer program, when executed by a computer, causes the computer to perform the steps including displaying a display region of one or more advertisement content 1112, wherein the displaying is performed by the display unit 1102, preloading an application in a memory of a mobile computing device 1002₁, 1002₂, . . . 1002_{N} based on data stored in a server 1012 for example: at least in part on the monitored activity and displaying an application launch icon in a launch area of a display of the mobile computing device, determining installation of at least one application on the mobile computing device in said display region, wherein the determining is performed by the display region determining unit 1104 and, determining location of an user by tracking location of the mobile computing device 1002₁, 1002₂, . . . 1002_{N}. Particularly, the determination is performed by the preloading controller 1104 and the downloading is performed by the preloading performing unit 1108.

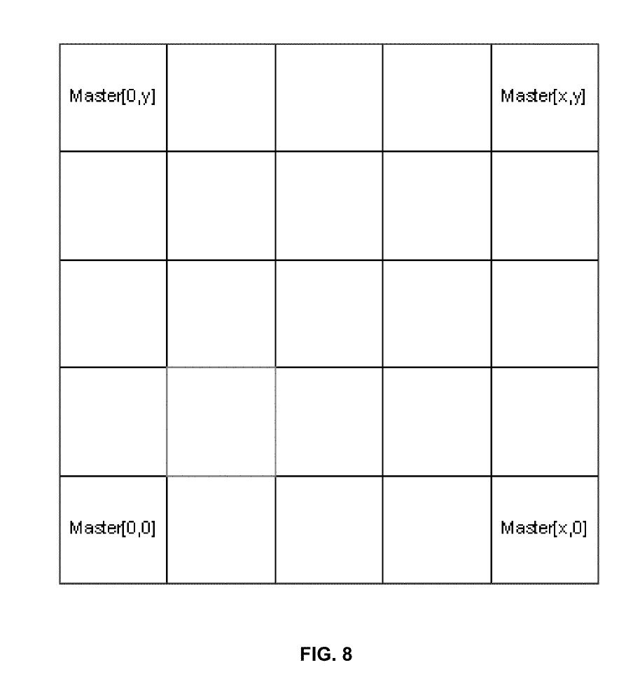

FIG. 8 is a pictorial snapshot illustrating subdivision of MEGA billboard, according to one embodiment of the present invention. In operation, the filled texture with advertisements are divided to MEGA zones called Master [x, y] and the data files are stored in the server 1012. Particularly, every master [x, y] zone is divided to subcell [x,y] zones and the master [x,y] folder includes json files Master.json and json files subcell [x,y].json.

Accordingly, the present invention provide systems, devices, apparatus and methods of retrieving information on a desktop computer 1008, 1010 or a handheld phone screen 1002₁, 1002₂, . . . 1002_{N} in an innovative way, with an aim to make them user friendly and more understandable for the standard users systems. The result of the present method is a new way to show the information around and near a center point. The method in this case is able to show the business near him ordered by distance, hecan scroll, zoom in and out the billboard. Moreover, the most interesting point is that even a small block but near the center is attracts the curiosity of the people, with a zoom in and out feature, the user is led to discover the blocks near his position.

One important advantage of the present invention is the capability to illustrate lot of information in a small space. Moreover, the present invention provide the big data generated in an efficient way to show millions of records in a view that is amazing to the human eye. Particularly, having two coefficients in the current method the present invention is able to illustrate one coefficient order by distance from the center and another coefficient is the dimension of the block. For example, in 1 million customers records, one block is assigned to each customer and use two coefficients, one is the total turnover and one is related to how many orders are made in a time range.

Particularly, the loyal big customer with a big turnover are illustrated from the center, and each one with a different size regarding loyalty. Therefore, the user who purchases periodically more has a big space. Another application can be AMAZON, where one coefficient is matching with one or more products. For example, if the user is put in the middle and each product around the user is considered as one block. When the product is more near the user there is a match in the system. In operation, millions of articles showed in a small picture is clickable and each article known to the user immediately position on the device.

Particularly, the billboard of the present invention provides the advantage of knowing is always one second for each record and exact location. Furthermore, the method of organizing the information in blocks, cells and concentric on the billboard is possible to be applied to many users. For example, the best customers of a company based on the present method provides a sorting data which can applied to Facebook or any other social media portal or messaging application. The present invention illustrates a new complete way and reach of the same is about hundred of friends the user has in a billboard that illustrates for example the best matching and feeling for love, friendship and other emotions. The present invention provides a method to utilize the billboard for marketing, by using it like a new way to discover business near you.

We claim:

1. A method of displaying at least one advertisement to at least one user selected from a billboard based on a plurality of parameters and preloading said billboard content performed by an apparatus for displaying said at least one advertisement content, wherein said apparatus comprises a display unit, a display region variation determining unit, a preloading controller, and a preloading performing unit, the method comprising:
displaying a display region of said at least one advertisement content, wherein said displaying is performed by said display unit;
preloading an application in a memory of a mobile computing device based on data stored in a server at least in part on a monitored activity and displaying an application launch icon in a launch area of a display of said mobile computing device;
determining installation of at least one application on a mobile computing device in said display region, wherein said determining is performed by said display region determining unit;
determining location of an user by tracking location of said mobile computing device;
wherein the determining is performed by the preloading controller; and wherein the downloading is performed by the preloading performing unit.

2. The method of claim 1, wherein a display region determining unit determines installation of at least one application on a mobile computing device.

3. The method of claim 2, further comprising receiving an input from said user regarding application launch and wherein it is determined that said at least one application is not accessible on said mobile computing device by said user, said method further comprising the steps of:
retrieving data from said server and storing application in said memory of said mobile computing device;
processing retrieved data from said server as a server deserialized data and displaying said retrieved data to said user by generating a plurality of visible advertisement blocks based on GPS location of said user and a plurality of parameters; and
creating texture and assigning map for touch event based on GPS location based on a field parameter for each visible advertisement block of said plurality of visible advertisement blocks;
wherein each visible advertisement block of said plurality of visible advertisement blocks are visible objects during pan or zoom.

4. The method of claim 3, further comprising receiving an input from said user regarding application launch and wherein it is determined that said at least one application is accessible on said mobile computing device by said user, said method further comprising the steps of:
retrieving said stored data by loading said application from said memory of said mobile computing device;
processing said stored data as mobile device deserialized data and displaying said retrieved data to said user by generating a plurality of visible advertisement blocks
Comparing said mobile device deserialized data version with data stored in said based on GPS location of said user and a plurality of parameters; server in real time;
determining whether size of said plurality of visible advertisement blocks stored in said server is more than said mobile device deserialized data version with data stored in said server; and
creating texture and assigning map for touch event based on GPS location based on a field parameter for each visible advertisement block of said plurality of visible advertisement blocks;
wherein each visible advertisement block of said plurality of visible advertisement blocks are visible objects during pan or zoom and size of said each visible advertisement block is defined by megaCellSize and processing is based on background as coroutine.

5. The method of claim 4, wherein said mobile device deserialized data version is replaced with said data stored in said server in real time when it is determined that said size of said plurality of visible advertisement blocks stored in said server is more than said mobile device deserialized data version with data stored in said server.

6. The method for providing advertisement information based on a user location of claim 1, wherein displaying at least one advertisement to at least one user is via an AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof; or the ticket and/or authorization is purchased and provided using the wireless device via the Internet, a WiFi connection, a network, a wireless network, a USB connection, or any combination thereof.

7. The method for providing advertisement information based on a user location of claim 1, further comprising determining the location of the wireless device: by comparing the timing of received locating signals, by comparing the phase of received locating signals, by comparing the relative arrival times of received locating signals, by triangulation, by a local positioning (LPS) device, by a global positioning system (GPS), or by any combination thereof.

8. The method for providing advertisement information based on a user location of claim 1, wherein the received locating signals are received by the wireless device via an AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

9. A non-transitory computer-readable recording medium having recorded thereon a computer program for displaying cartoon content, said computer program, when executed by a computer, causes the computer to perform the steps comprising:
displaying a display region of said at least one advertisement content, wherein said displaying is performed by said display unit;
preloading an application in a memory of a mobile computing device based on data stored in a server at least in part on a monitored activity and displaying an application launch icon in a launch area of a display of said mobile computing device;
determining installation of at least one application on a mobile computing device in said display region, wherein said determining is performed by said display region determining unit; and
determining location of an user by tracking location of said mobile computing device;
wherein the determining is performed by the preloading controller; and wherein the downloading is performed by the preloading performing unit.

10. A system for displaying at least one advertisement to at least one user selected from a billboard based on a plurality of parameters and preloading said billboard content performed by an apparatus for displaying said at least one advertisement content on a local handheld device, said system comprising:
a display unit, a display region variation determining unit, a preloading controller, and a preloading performing unit, including a display region of said at least one advertisement content, wherein said displaying is performed by said display unit with a preloading an application in a memory of a mobile computing device based on data stored in a remote server;
one or more processors; and one or more computer-readable media having stored thereon instructions that are executable by said one or more processors to configure said system to display one or more advertisements, including instructions that are executable to configure said system to perform at least the following:
at said mobile computing device connect to said remote server, wherein said remote server provides location of said user by tracking location of said mobile computing device; wherein the determining is performed by said preloading controller; and wherein the downloading is performed by said preloading performing unit;
receive input from said remote server and said remote server provides said input from said user regarding application launch;
determining at said mobile computing device the location of the wireless device; at said said mobile computing device obtain receiving locating signals by said wireless device;
wherein said remote server provide displaying an application launch icon in a launch area of a display of a mobile computing device and a display region determining unit determines installation of at least one application on a mobile computing device.

11. The system for providing advertisement information based on a user location of claim 10, wherein said one or more mobile computing device further have stored thereon instructions that are executable by the one or more processors to configure said system in said mobile computing device to cause said mobile computing device to display region determining unit determines installation of at least one application on a mobile computing device.

12. The system of claim 10, wherein it is determined that said at least one application is not accessible on said mobile computing device by said user, said system further comprising the steps of:
retrieving data from said server and processing retrieved data from said server as a server deserialized data and displaying said retrieved data to said user by generating a plurality of visible advertisement blocks based on GPS location of said user and a plurality of parameters based on real time and creating texture and assigning map for touch event based on GPS location based on a field parameter for each visible advertisement block of said plurality of visible advertisement blocks and visible objects viewed during pan or zoom.

13. The system of claim 10, wherein it is determined that said at least one application is not accessible on said mobile computing device by said user, said system further comprising the steps of:
retrieving data from said server and processing retrieved data from said server as a server deserialized data and displaying said retrieved data to said user by generating a plurality of visible advertisement blocks based on GPS location of said user and a plurality of parameters based on real time and creating texture and assigning map for touch event based on GPS location based on a field parameter for each visible advertisement block of said plurality of visible advertisement blocks is defined by mega Cell Size and processing is based on background as coroutine.

14. The system of claim 13, wherein said mobile device deserialized data version is replaced with said data stored in said server in real time when it is determined that said size of said plurality of visible advertisement blocks stored in said server is more than said mobile device deserialized data version with data stored in said server.

15. The system for providing advertisement information based on a user location of claim 10, wherein displaying at least one advertisement to at least one user is via plurality of means AM signal, an FM signal, a phase modulated signal, CDMA, TDMA, spread spectrum, the Internet, a WiFi connection, a Bluetooth connection, a Zigbee connection, a network, a wireless network, a 3G network, a 4G network, a USB connection, or any combination thereof.

16. The system for providing advertisement information based on a user location of claim 10, further comprising determining the location of the wireless device: by comparing the timing of received locating signals, by comparing the phase of received locating signals, by comparing the relative arrival times of received locating signals, by triangulation, by a local positioning (LPS) device, by a global positioning system (GPS), or by any combination thereof.

17. The system for providing advertisement information based on a user location of claim 10, wherein the received locating signals are received by the wireless device via an AM signal, an FM signal, a phase modulated signal, COMA, TDMA, spread spectrum, the Internet, a WiFi connection, a Bluetooth connection, a Zigbee connection, a network, a wireless network, a 3G network, a 4G network, a USB connection, or any combination thereof.
